(19) United States
(12) Patent Application Publication
(10) Pub. No.: US 2011/0138280 A1
(43) Pub. Date: Jun. 9, 2011

(54) PLAYLIST MANAGEMENT

(76) Inventors: Wes Albert Nagara, Commerce Township, MI (US); John Thomas Kosinski, II, River Rouge, MI (US)

(21) Appl. No.: 12/630,864

(22) Filed: Dec. 4, 2009

(51) Int. Cl. G06F 3/00

(52) U.S. Cl. 715/716

(57) ABSTRACT

A management system for managing a media in a vehicle is disclosed. The management system includes a storage device for storing at least one playlist therein, a vehicle system in data communication with the storage device, wherein the vehicle system transmits a media output to a user, and a user interface in data communication with at least one of the vehicle system and the storage device, the user interface including an add button for associating the media output to the at least one playlist and a delete button for disassociating the media output from the at least one playlist.

### FIELD OF THE INVENTION

The present invention relates generally to a playlist for digital media. More particularly, the invention is directed to a management system for a digital media in a vehicle and a method for managing a playlist.

### BACKGROUND OF THE INVENTION

Current infotainment systems include multiple music and video devices that contain multiple audio files and video files. Often, the audio files and video files are arranged into a plurality of playlists based upon user preferences. Managing the playlists typically requires a direct attention of the user which can lead to distraction from other concurrent tasks, such as driving.

One issue with playlist management in a vehicle is that the user must spend time navigating through a large list of media files. Certain portable audio/video devices (e.g. iPod® devices) have a press and hold feature to add a song to a playlist. However, a user is not able to remove a song without using a separate computer. Other interfaces use a desktop method having multiple lists and controls which require a long task time and can cause distraction in a vehicle environment.

It would be desirable to develop a management system for a digital media in a vehicle and a method for managing a playlist, wherein the management system and the method provide an efficient means to associate the digital media with at least one playlist and to dissociate the digital media with the at least one playlist using a single user interface in the vehicle.

### SUMMARY OF THE INVENTION

Concordant and consistent with the present invention, a management system for a digital media in a vehicle and a method for managing a playlist, wherein the management system and the method provide an efficient means to associate the digital media with at least one playlist and to dissociate the digital media with the at least one playlist using a single user interface in the vehicle, has surprisingly been discovered.

In one embodiment, a management system for managing a media in a vehicle comprises: a storage device for storing at least one playlist therein; a vehicle system in data communication with the storage device, wherein the vehicle system transmits a media output to a user; and a user interface in data communication with at least one of the vehicle system and the storage device, the user interface including an add button for associating the media output to the at least one playlist and a delete button for disassociating the media output from the at least one playlist.

In another embodiment, a management system for managing a media in a vehicle comprises: a storage device for storing a plurality of playlists therein; a vehicle system in data communication with the storage device, wherein the vehicle system transmits a media output to a user; and a user interface in data communication with at least one of the vehicle system and the storage device, the user interface including a playlist button for selecting a particular one of the playlists to manage, an add button for associating the media output to the particular playlist, a delete button for disassociating the media output from the particular playlist.

The invention also provides methods for managing a playlist in a vehicle.

One method comprises the steps of: providing a storage device for storing a playlist therein; providing a vehicle system in data communication with the storage device, wherein the vehicle system transmits a media output to a user; and providing a user interface in data communication with at least one of the vehicle system and the storage device, the user interface including a playlist button representing the playlist; wherein the user engages an add button of the user interface to initiate an addition command and subsequently engages the playlist button to associate the media output of the vehicle system to the playlist represented by the engaged playlist button; and wherein the user engages a delete button of the user interface to initiate a deletion command to disassociate the media output of the vehicle system from the playlist.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a front fragmentary perspective view of an interior of a vehicle including a management system according to an embodiment of the present invention;

FIG. 2 is schematic representation of a display of the management system of FIG. 1; and

FIG. 3 is a schematic flow diagram of a method for managing a playlist according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

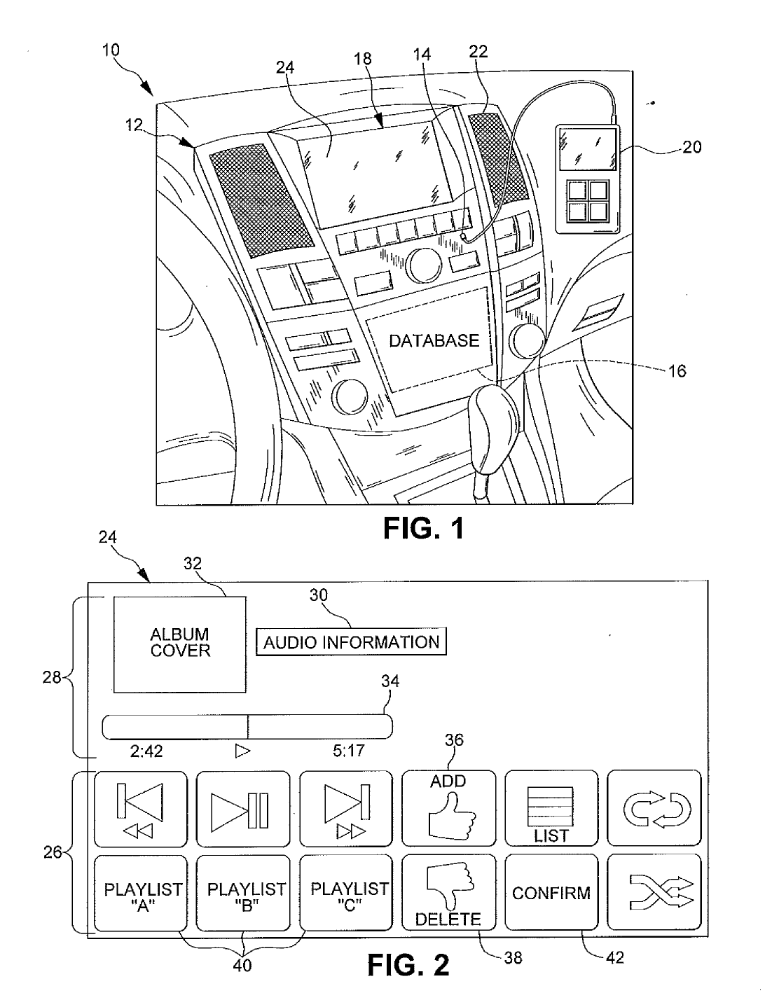

FIGS. 1-2 illustrate a management system 10 disposed in a vehicle control panel 12 according to an embodiment of the present invention. The management system 10 includes an input 14, a database 16, and a user interface 18.

The input 14 facilitates an interconnection between the management system 10 and an electronic device 20 for transferring data therebetween. It is understood that any means for interconnection may be used such as a hard wire connection, a wireless connection, a network connection, a Bluetooth® connection, and a connection over the Internet, for example. It is further understood that the electronic device 20 may be any device capable of storing a digital media such as a portable consumer electronic device, a peripheral storage and playback device, and an integrated media playback device, for example. As shown, the electronic device 20 is a, portable music device having a plurality of audio files arranged in a plurality of playlists such as an Ipod® portable music device, for example.

The database 16 may be any storage device for storing data such as digital audio files, video files, and playlists, for example. The database 16 is adapted to communicate with the input 14 to send and receive data such as digital audio files, for example. The database 16 is also in communication with the user interface 18, wherein a command signal received from the user interface 18 controls at least one of a storing, a retrieving, and an organizing of the data stored on the database 16. In the embodiment shown, the database 16 is disposed in the vehicle. However, the database 16 may be disposed in a remote location and connected to the user interface 18 via the Internet or other suitable communication means. It is understood that the database 16 may be associated with any vehicle system and may store any data. It is further understood that a playlist stored on the database 16 may be populated by a plurality of media files stored in various locations. For example, the media files can be stored on a media storage device such as the database 16, the electronic device 20, a compact disc (CD) that is loaded in a CD player integrated with the vehicle, and a peripheral device in communication with the database 16. As a further example, the playlist operates as a sequential catalog of the media files stored in various locations.

The user interface 18 may be integrated into any component and in any position in a vehicle such as a center stack and an infotainment head unit, for example. The user interface 18 controls the storing, the retrieving, and the organizing of a data associated with the database 16. The user interface 18 is also adapted to receive user-provided commands to control a function of at least one vehicle system 22 in response to the user-provided command. In the embodiment shown, the vehicle system 22 is an audio system for controlling audio playback. As a non-limiting example, the vehicle system 22 is adapted to transmit a media output to the user such as music, for example. As a further non-limiting example, the vehicle system 22 includes a radio to receive radio waves and generate the media output based upon the received radio waves. In certain embodiments, the vehicle system 22 is connected to the Internet to receive an input signal and generate the media output based upon the received input signal. It is understood that the media output generated by the vehicle system 22 or any of the vehicle systems can be based upon any input received from any remote source or local source, as desired. It is further understood that the user interface 18 can control any vehicle system, as desired.

The user interface 18 includes a display 24 for presenting information to a user. As a non-limiting example, the display 24 is a touch screen for receiving the user-provided input to control a function of the vehicle system 22 associated with the user interface 18.

The display 18 presents a plurality of control elements 26 to the user along with a play-back information 28. As shown, the display 18 presents an audio information 30 relating to a current song being played through the vehicle system 22. The audio information 30 may include a song name, an artist name, an album name, and other information relating the song. As a non-limiting example, the audio information 30 includes at least one of a song name, an artist, an album name, an album date. In certain embodiments, an Internet-based software (e.g. Gracenotes) is used to retrieve the audio information 30 relating to a particular song or media. The play-back information 28 may also include visual displays such as an album cover artwork 32 associated with the song being played through the vehicle system 22 and a current audio track data 34 representing a song length and current play-back position. However, it is understood that any information can be shown on the display 18.

The control elements 26 may include an add button 36 for associating a particular song or audio file with a selected playlist, a delete button 38 for selectively removing a song or audio file from a playlist, a plurality of playlist buttons 40 for selecting a particular playlist to organize and manage (e.g. add and delete media), and a confirmation button 42 for authenticating or confirming a user-provided command. As a non-limiting example, each of the control elements 26 is a touch screen button presented on the display 18. However, it is understood that any button or interface may be used such as an electromechanical button, for example. It is further understood that the control elements 26 may include other features such as additional playlist buttons, a play button, a forward button, a reverse button, and a repeat button, for example.

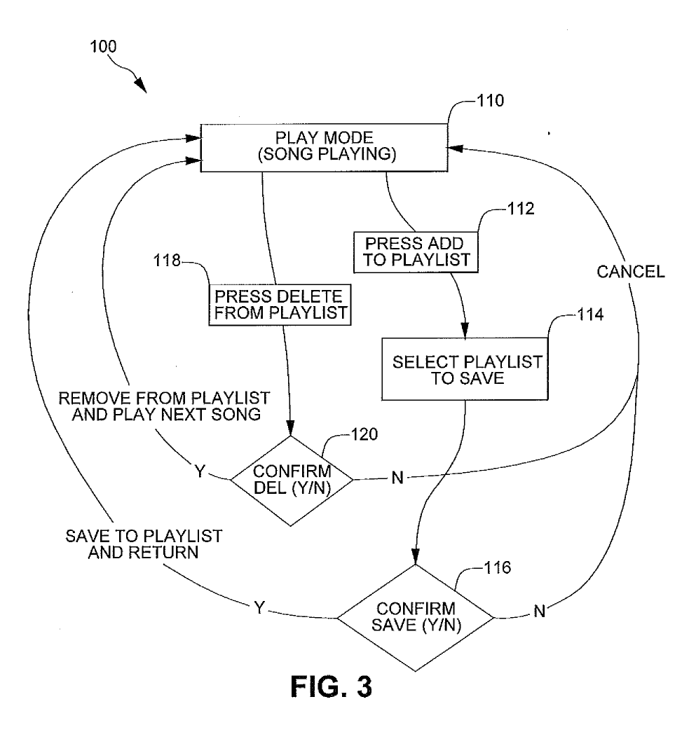

FIG. 3 illustrates a method 100 for managing a playlist. In step 110, the vehicle system 22 is in a “play mode” and the play-back information 28 on the display 24 of the interface 18 presents the audio information 30 relating to the current song or audio/video transmission. It is understood that the user interface 18 may be adapted to receive user-provided commands without disrupting the playback of the current song through the vehicle system 22.

In step 112, the user engages the add button 36 thereby initiating an addition command to associate the current song with at least one of the plurality of playlists. The user then selects a particular playlist by engaging one of the playlist buttons 40, as shown in step 114. In step 116, the user is prompted to confirm the addition of the current song to the playlist represented by the selected one of the playlist buttons 40. The confirmation button 42 allows the user to confirm the addition command or cancel the addition command and return to the normal play mode at step 110. Where the user confirms the addition command, the song that is currently being played through the vehicle system 22 is associated with the selected playlist. Thereafter, when the selected playlist is activated, the vehicle system 22 initiates a sequential playback of the digital media associated with the playlist. Where a particular associated song or digital media file cannot be located (i.e. not stored on the database 16 or any peripheral in communication with the database 16), the song is skipped and the vehicle system 22 initiates playback of the next song in the playlist. In certain embodiments, the add button 36 is engaged to “tag” a current song for later purchase and subsequent association with a particular playlist.

In step 118, the user engages the delete button 38 thereby initiating a deletion command to disassociate the current song from a selected playlist. In step 120, the user is prompted to confirm the deletion of the song from the selected playlist. The confirmation button 42 allows the user to confirm the deletion command or cancel the deletion command and return to the normal play mode at step 110. Where the user confirms the deletion command, the song that is currently being played is disassociated from the currently selected playlist. In certain embodiments, the vehicle system 22 automatically initiates a playback of the next song on the selected playlist.

The management system 10 and the methods described herein provide an efficient means to associate a digital media with at least one playlist and to dissociate the digital media from the at least one playlist using the single user interface 18. The management system 10 allows a user to add and delete a plurality of digital media to/from a plurality of playlists. Digital media associated with a particular playlist can be stored on any device and placed in data communication with the management system 10 in order to populate the playlist for play-back.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A management system for managing a media in a vehicle, the management system comprising:
a storage device for storing at least one playlist therein;
a vehicle system in data communication with the storage device, wherein the vehicle system transmits a media output to a user; and
a user interface in data communication with at least one of the vehicle system and the storage device, the user interface including an add button for associating the media output to the at least one playlist and a delete button for disassociating the media output from the at least one playlist.

2. The management system according to claim 1, wherein the vehicle system is an audio system.

3. The management system according to claim 1, wherein the vehicle system receives an input signal and transmits the media output based upon the input signal.

4. The management system according to claim 1, wherein the media output transmitted by the vehicle system is associated with a digital media file.

5. The management system according to claim 4, wherein the digital media file is stored on at least one of the storage device and an electronic device in data communication with at least one of the storage device, the vehicle system, and the user interface.

6. The management system according to claim 1, wherein the user interface is a touch screen.

7. The management system according to claim 1, wherein at least one of the add button and the delete button is presented on a touch screen display of the user interface.

8. The management system according to claim 1, wherein the user interface is disposed on a vehicle center stack.

9. The management system according to claim 1, further comprising an input in data communication with the storage device for interconnecting the storage device and an electronic device to at least one of send and receive data therebetween.

10. A management system for managing a media in a vehicle, the management system comprising:
a storage device for storing a plurality of playlists therein;
a vehicle system in data communication with the storage device, wherein the vehicle system transmits a media output to a user; and
a user interface in data communication with at least one of the vehicle system and the storage device, the user interface including a playlist button for selecting a particular one of the playlists to manage, an add button for associating the media output to the particular playlist, a delete button for disassociating the media output from the particular playlist.

11. The management system according to claim 10, wherein the vehicle system is an audio system.

12. The management system according to claim 10, wherein the media output transmitted by the vehicle system is associated with a digital media file.

13. The management system according to claim 12, wherein the digital media file is stored on at least one of the storage device and an electronic device in data communication with at least one of the storage device, the vehicle system, and the user interface.

14. The management system according to claim 10, wherein the user interface is a touch screen.

15. The management system according to claim 10, wherein at least one of the add button and the delete button is presented on a touch screen display of the user interface.

16. The management system according to claim 10, wherein the user interface is disposed on a vehicle center stack.

17. The management system according to claim 10, further comprising an input in data communication with the storage device for interconnecting the storage device and an electronic device to send and receive data therebetween.

18. A method for managing a playlist in a vehicle, the method comprising the steps of:
providing a storage device for storing a playlist therein;
providing a vehicle system in data communication with the storage device, wherein the vehicle system transmits a media output to a user; and
providing a user interface in data communication with at least one of the vehicle system and the storage device, the user interface including a playlist button representing the playlist;
wherein the user engages an add button of the user interface to initiate an addition command and subsequently engages the playlist button to associate the media output of the vehicle system to the playlist represented by the engaged playlist button; and
wherein the user engages a delete button of the user interface to initiate a deletion command to disassociate the media output of the vehicle system from the playlist.

19. The method according to claim 18, wherein the user interface includes a confirmation button for confirming at least one of the addition command and the deletion command.

20. The method according to claim 18, wherein at least one of the playlist buttons, the add button, and the delete button is presented on a touch screen display of the user interface.
